(19) United States
(12) Patent Application Publication
(10) Pub. No.: US 2026/0318118 A1
(43) Pub. Date: Oct. 15, 2026

(54) DOOR LOCK HAVING A LATCH BOLT

(71) Applicant: Abloy Oy, Joensuu (FI)

(72) Inventor: Juha Raatikainen, Joensuu (FI)

(21) Appl. No.: 19/370,050

(22) Filed: Oct. 27, 2025

(30) Foreign Application Priority Data
Oct. 28, 2024 (FI) 20246277

(51) Int. Cl. E05B 55/12

(52) U.S. Cl. CPC E05B 55/12

(57) ABSTRACT

A door lock has a lock body, a latch bolt and an auxiliary bolt. The door lock further includes a turnable lever member, which is turnably connected to the body part. The turnable lever member is arranged to pull the auxiliary bolt inside the door lock when the latch bolt is moved inside the door lock. When the door lock is not against a door frame, the latch bolt is arranged to remain its position regardless of a position of the auxiliary bolt.

### FIELD OF TECHNOLOGY

The invention relates to a door lock having a latch bolt. Especially the invention relates to a door lock wherein the extent of protrusion of the latch bolt is controlled.

### PRIOR ART

In door locks provided with a latch bolt two different protruding positions with different extent of protrusion may be arranged for the latch bolt. In the first position the door can be pressed to be closed whereby the oblique surface of the latch bolt hits a striking plate in the doorframe, which presses the latch bolt against its spring inside the lock. The second protruding position of the latch bolt is intended for the actual locking of the door, and in this position of the latch bolt the door cannot be pressed to be closed. This position is called as a dead locked position.

It is known that the door lock comprises also an auxiliary bolt the purpose of which is to prevent movement of the latch bolt into its outermost position (the dead locked position) when the door is open, and on the other hand to allow the latch bolt to move into its outermost position urged by its spring after the door is pressed closed.

A malfunction may occur when the auxiliary bolt is by accident pressed in when the door is open, the latch bolt is simultaneously released into its outermost position and thus prevents closing of the door by pressing.

### SHORT DESCRIPTION

The object of the invention is to eliminate the problem said above. The object is achieved in a way described in the independent claim. Dependent claims illustrate different embodiments of the invention.

A door lock according to the invention has lock body, a latch bolt and an auxiliary bolt. The latch bolt comprises an oblique part and a body part. The auxiliary bolt comprises a wedge part and an arm part. The door lock further comprises a turnable lever member, which is turnably connected to the body part. The turnable lever member comprises a detent surface and a connection surface. The arm part comprises a counter connection surface, and the door lock comprises a counter detent surface in connection with the body part.

The turnable lever member is arranged to pull the auxiliary bolt inside the door lock when the latch bolt is moved inside the door lock. The detent surface is against the counter detent surface and the connection surface is against the counter connection surface when pulling the auxiliary bolt.

When the door lock is not against a door frame, the oblique part mostly outside the door lock, the latch bolt is arranged to remain its position regardless of a position of the auxiliary bolt by a retainer surface of the turnable lever member and a counter retainer surface of the lock body.

The retainer surface is arranged to be against the counter retainer surface in said position of the oblique part mostly outside the door lock when the door is not against the door frame.

### LIST OF FIGURES

In the following, the invention is described in more detail by reference to the enclosed drawings, where

FIG. 1 illustrates an example of a door lock according to the invention the bolt in the dead locked position, the door being closed,

FIG. 2 illustrates the example of FIG. 1 according to the invention when pulling the latch bolt inside the door lock,

FIG. 3 illustrates an example of FIG. 1 according to the invention the latch bolt and the auxiliary bolt being pulled inside the door lock,

FIG. 4 illustrates an example of FIG. 1 according to the invention when the door is open and the latch bolt is in the first protruding position,

FIG. 5 illustrates an example of FIG. 1 according to the invention when closing the door and the latch bolt moving towards the dead locked position,

FIG. 6 illustrates an example of a latch bolt, an auxiliary bolt and a rocker lever according to the invention,

FIG. 7 illustrates an example of a latch bolt, an auxiliary bolt and a rocker lever according to the invention within a module structure, and

FIG. 8 illustrates an example of a different embodiment of the rocker lever.

### DESCRIPTION OF THE INVENTION

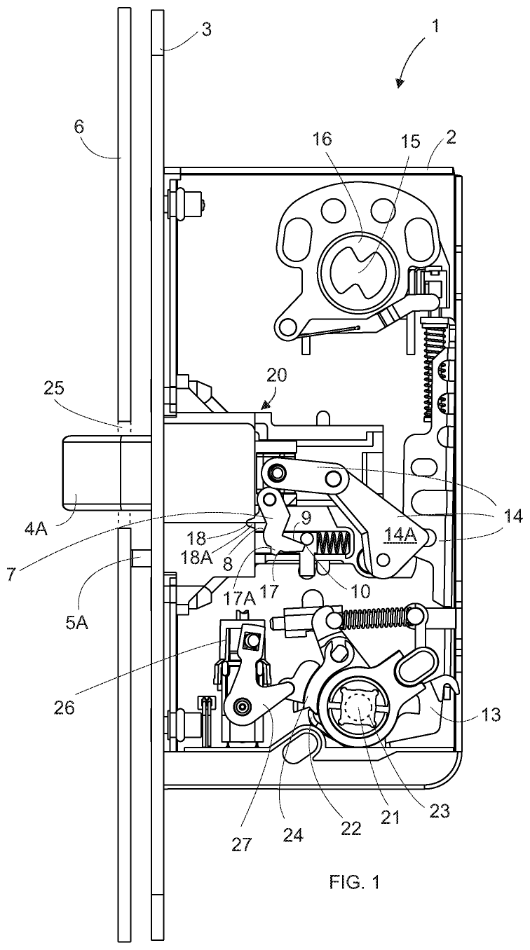

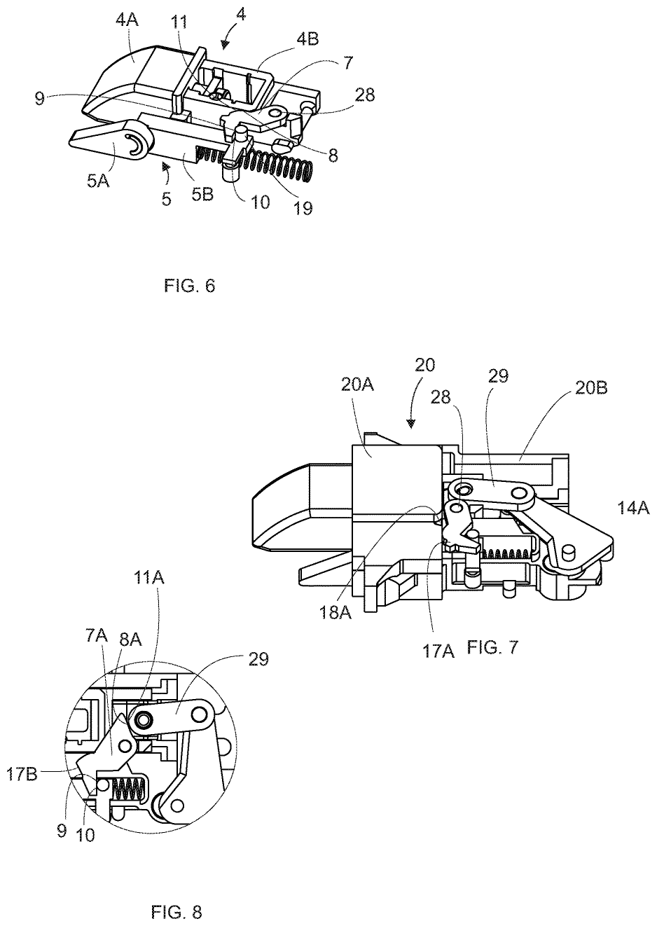

FIG. 1 illustrates an example of a door lock 1 according to the invention when its bolt is outside in the dead locked position (the second protruding position). In other words, the lock is in a locked state. The door lock according to the invention 1 has lock body 2, a latch bolt 4 and an auxiliary bolt 5. The latch bolt comprises an oblique part 4A and a body part 4B. The auxiliary bolt 5 comprises a wedge part 5A and an arm part 5B. See FIG. 6. The door lock further comprises a turnable lever member 7, which is turnably connected to the body part 4B. The turnable lever member 7 comprises a detent surface 8 and a connection surface 9. The arm part 5B comprises a counter connection surface 10, and the door lock comprises a counter detent surface 11 in connection with the body part 4B.

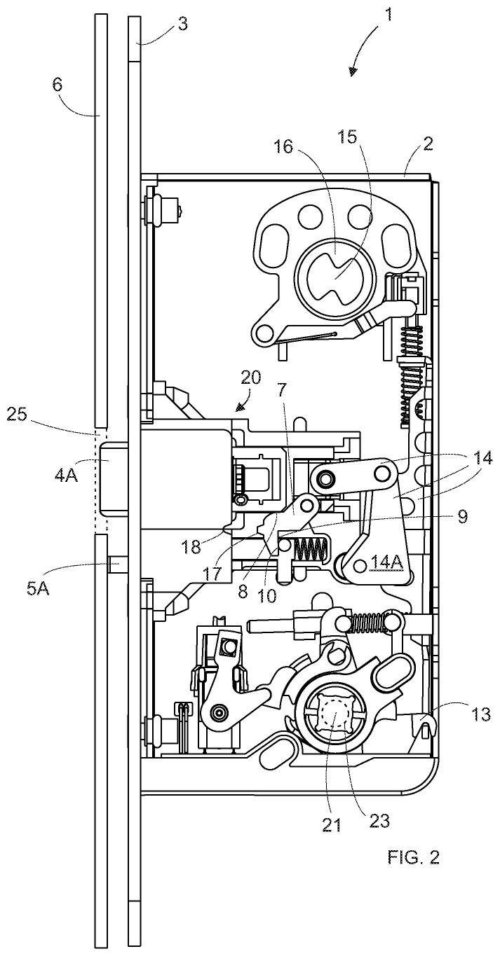

The turnable lever member is arranged to pull the auxiliary bolt 5 inside the door lock 1 when the latch bolt 4 is moved inside the door lock. FIG. 2 shows the situation when the latch bolt is pulled inside the door lock, i.e. inside the lock body 2. The pulling force is transmitted to the latch bolt 4 through force transmission means 14 from a follower 13 or the lock cylinder torsion element 16.

The detent surface 8 is against the counter detent surface 11 and the connection surface 9 is against the counter connection surface 10 when pulling the auxiliary bolt 5. So, through the rocker lever 7 the auxiliary bolt is also moved inside the lock body when moving the latch bolt inside the lock body.

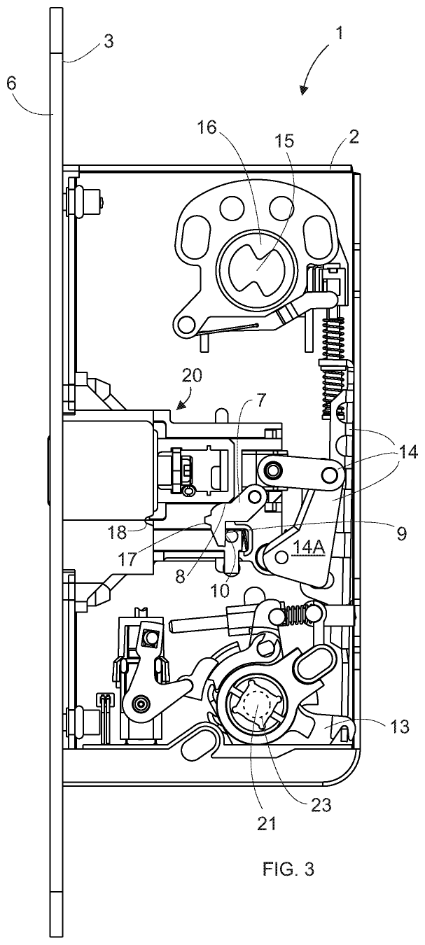

FIG. 3 shows the door lock of FIG. 1 when the latch bolt is inside the door lock. In other words the lock is in an unlocked state, and the door, when the lock is installed in the door, can be opened. The auxiliary bolt 5 is also inside the door lock. In FIG. 3 the handle (not illustrated in the figure) is pressed keeping the latch bolt and also the auxiliary bolt inside the door lock, more precisely in the lock body.

As said the door lock has a lock body 2. The lock body 2 comprises a front plate 3 with a bolt hole 25 through which the latch bolt 4 of the lock is movable. In addition, the lock body 2 is provided with an operation axis 21. The operation axis is the place whereto a follower 13 is installed. The follower is turnably supported in relation to the lock body 2, and the follower as shown in the figures acts on the latch bolt 4 of the lock through separate force transmission means 14. In the example of FIGS. 1 and 2 the force transmission means 14 comprises plates, a lever, and other parts, which are referred together as the force transmission means. For clarification, if in this description, it is said that the force transmission means is connected to an element, it means that at minimum only one part of the force transmission means, like the lever, is enough to provide said connection with the element.

In practice, in cases when the door lock is provided with handles or knobs the follower 16 can be affected from both sides of the lock case. The handle or the knob on one side of the lock is in connection with a torsion unit 22, which is on same side of the follower 13 than the handle. The same arrangement is on the other side of the door lock. The handle is installed on a spindle, which is in direct contact with the torsion unit 13. A dashed line circle 23 illustrates the spindle of the handle, which can be installed on the door lock according to the invention.

The force transmission required by the handle operation is arranged by means of a coupling member 24, which has two selectable operating positions, a force transmission coupling position, in which the latch bolt 4 of the lock can be moved by means of the handle, and a force transmission decoupling position, in which the latch bolt 4 of the lock correspondingly cannot be affected by means of the handle. FIGS. 1-5 show the force transmission coupling position driven by, for example, a solenoid 26 via its cam plate 27. The functioning of the torsion units 22, the follower 13, the coupling member 24, and the solenoid or another actuator, is known as such, although the figures do not show the decoupling position of the coupling member 24.

Another way to move the latch bolt 4 may be turning a key to open a cylinder lock attached (not illustrated in the figures) on a lock cylinder axis 15 of the door lock. The lock cylinder axis is the place whereto the cylinder lock and a cylinder torsion element 16 are installed. The cylinder lock is in connection with the cylinder torsion element 16, which in turn is in connection with said force transmission means 14. After opening the cylinder lock, the force turning the key is transmitted through the force transmission means 14 to the latch bolt 4 for moving it inside the lock body. The door lock according to the invention may have both ways to move the latch bolt or one of them.

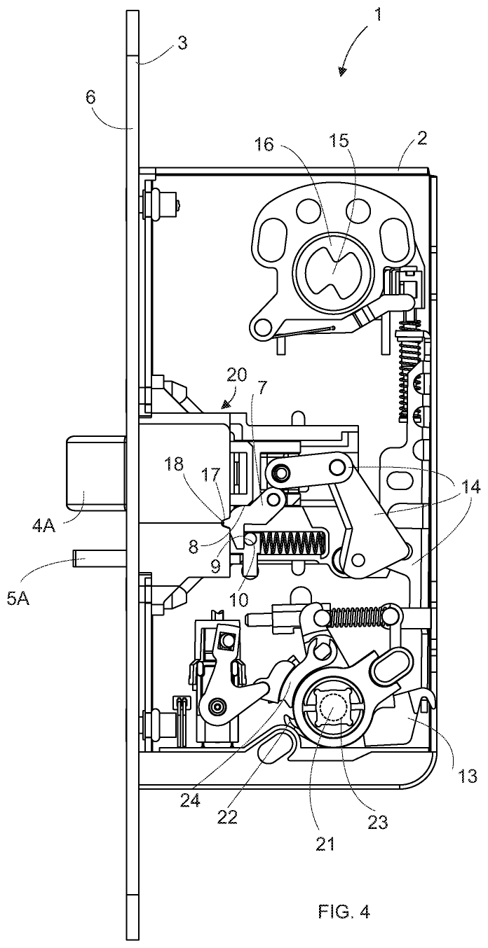

When the door lock is not against a door frame, the oblique part 4A mostly outside the door lock, the latch bolt 4 is arranged to remain its position regardless of a position of the auxiliary bolt 5 by a retainer surface 17 of the turnable lever member 7 and a counter retainer surface 18 of the lock body. FIG. 4 illustrates this situation.

When the handle is not turned any more, or the key is turned back, there is no force to keep the latch bolt 4 inside the lock body 2, so the springs biasing the latch bolt 4 and the auxiliary bolt outside the lock body, move the latch bolt and the auxiliary bolt to protrude out from the lock body. The movement of the auxiliary bolt 5 affected through the counter connection surface 10 keeps the rocker lever 7 in the position where the detent surface 8 is against the counter detent surface 11. In that position when the latch bolt 4 moves out the first protruding position (illustrated in FIG. 4), the retainer surface 17 meets the counter retainer surface 18. So, the retainer surface 17 is arranged to be against the counter retainer surface 18 in said position of the oblique part 4A mostly outside the door lock when the door is not against the door frame. As can be seen in FIG. 4 the protruding position of the auxiliary bolt 5 is not restricted by the striker plate 6.

If the auxiliary bolt is by accident pressed in when the door is open in a situation like in FIG. 4, the auxiliary bolt 5 moves inside the lock body 2, but the latch bolt 4 remains in the first protruding position. The coupling between the connection surface 9 and the counter connection surface 10 is decoupled. The retainer surface 17 against the counter retainer surface 18 prevents the latch bolt 4 to move to the dead locked position.

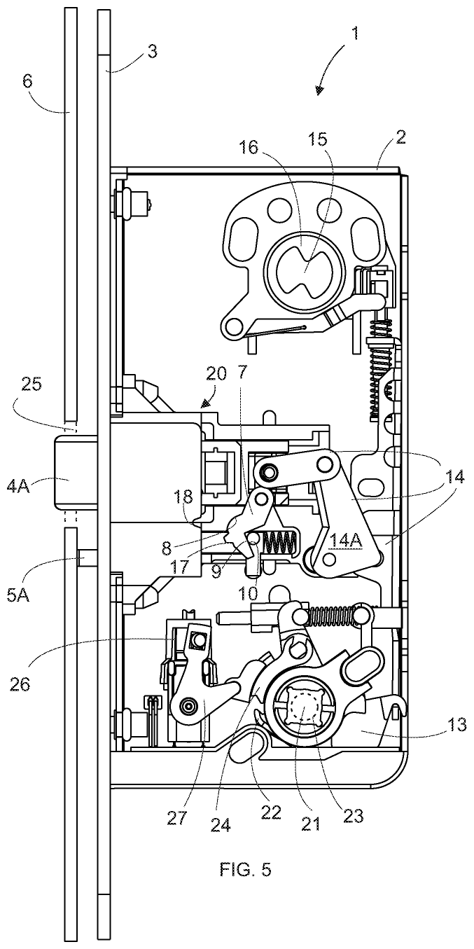

FIG. 5 illustrates a situation of closing the door and the latch bolt 4 moving towards the dead locked position. The door and therefore the door lock 1 is against the door frame and the striker plate 6. The latch bolt 4 and the auxiliary bolt 5 hit the striker plate, which drives the both bolts to move inside the lock body. Then the oblique part 4A of the latch bolt is moving through the hole 25 of the striker plate towards the dead locked position. The latch bolt and the auxiliary bolt are spring loaded to protrude outside the lock body 2. The striker plate 6 prevents the wedge part 5A of the auxiliary bolt to protrude further outside the lock body 2. Therefore, the arm part 5B of the auxiliary part does not move either, and the movement of the latch bolt 4 in relation to the auxiliary bolt 5 makes it possible that the rocker lever 7 turns to a position where it does not prevent the latch bolt to move to the second protruding position. As said, FIG. 1 shows the second protruding position, and shows the final position of the latch bolt when closing the door.

FIG. 6 illustrates an example of latch bolt 4, an auxiliary bolt 4 and a rocker lever 7 according to the invention. As can be seen the rocker lever is turnably connected to to the body part 4B utilizing a pivot 28.

FIG. 7 illustrates an example of the latch bolt, the auxiliary bolt and the rocker lever according to the invention within a module structure 20 inside the lock body. This module structure embodiment comprises an upper cover 20A, and a larger bottom cover 20B. The latch bolt, the auxiliary bolt and the rocker lever are in the module structure. Thus, the module structure comprising them. The module structure 20 is connected to the lock body 2 and/or the front plate, so it provides a corresponding support for the latch bolt, the auxiliary bolt and the rocker lever if they would have installed directly to the lock body. The modular structure makes the installation easier and it also makes easier to provide different embodiments, like using a different latch bolt embodiment or a different rocker lever embodiment.

In addition, the module structure 20 can be used to provide a support for a part of the force transmission means, as the case is in the figures. In the embodiments of the figures The part of the force transmission means supported on the module structure is a plate part 14A. It is turnably connected to the module structure 20. In the embodiments of the figures, the plate part 14A is also turnably connected to the lever 29, which is also turnably connected to the body part 4B of the latch bolt. So, the module structure can also be utilized to provide support connections for some parts of the force transmission means 14, which can also make the installation easier. However, the use of the module structure is only one way to construct the door lock according to the invention. The lock body 2 can also be utilized to have support connections for the parts of the force transmission means, and for the latch bolt, and the auxiliary bolt.

FIG. 8 illustrates an example of a different embodiment of the rocker lever 7A. In this embodiment the detent surface 8A has a different shape on the rocker lever 7A. The counter detent surface 11A is provided by a part of the lever 29, which is turnably connected to the body part 4B. So, the counter detent surface 11A is in connection with the body part. As said above, the lever is part of the force transmission means 14. In other words, the counter detent surface 11 can be a part of one part of the force transmission means 14.

Note that the previous figures show the other solution wherein the counter detent surface 11 is a part of the body part, more precisely the part of the surface of the body part 4A, and thus having itself a connection with the body part. The connection surface and the counter connection surface 10, are the same in FIG. 8 as in the FIGS. 1-7. The retainer surface 17B of the turnable lever member has a different shape in the embodiment of FIG. 8 than in the embodiments of FIGS. 1-7. Therefore, the counter retainer surface of the door lock has also a shape matching the shape of the retainer surface 17B in FIG. 8.

It is worth to mention that the counter retainer surface 18 can be made on the inner side of the lock body 2, being a part of the lock body or a part connected to the lock body. The counter retainer surface 18 can also be a part of the module structure 20 as illustrated in the figures. In other words, the module structure comprises the counter retainer surface.

As can be seen in the FIGS. 1-7 the turnable lever member 7 can comprise a projection 17A which provides the retainer surface 17, and the lock body comprises a recess 18A for the projection, which recess provides the counter retainer surface 18. As can be noted the counter retainer surface can be a part of the module structure, or as said above the part of the lock body 2. The projection 17A is arranged to be in the recess 18A when the door lock is not against a door frame, the latch part mostly outside the door lock. The projection against the recess prevents the latch bolt to move to the dead locked position.

In addition, it can be seen in the figures that the counter connection surface 10 is towards the front plate 3, and the counter connection surface 10 can be a part of a pin 19. The pin in turn is a part of the arm part 5B.

As said above the lock body can comprise a lock cylinder torsion element 16 and/or a follower 13 of an operation axis 12, and force transmission means 14 to move the latch bolt 4 inside the lock body. The force transmission means 14 are in connection with latch bolt 4 and also with the lock cylinder torsion element 16 and/or the follower 13 of the operation axis.

Although, the embodiment illustrated in FIGS. 1-5 has the electric actuator (the solenoid or another electric actuator, like an electric motor) the door lock according to the invention can also be realized without electric means so the door lock can be purely a mechanical lock.

As can be noticed the invention can be made in many different ways. When the door lock is not against a door frame, the latch bolt in the first protruding position outside the door lock, the latch bolt is arranged to remain its position regardless of a position of the auxiliary bolt. Even if the auxiliary bolt is pressed inside the door lock once or several times, the latch bolt keeps it first protruding position. Functioning of the door lock according to the invention is more reliable.

It is evident from the above that the invention is not limited to the embodiments described in this text but can be implemented in many other different embodiments within the scope of the independent claim.

1. A door lock (1) having lock body (2), a latch bolt (4) and an auxiliary bolt (5), the latch bolt comprising an oblique part (4A) and a body part (4B), the auxiliary bolt (5) comprising a wedge part (5A) and an arm part (5B), characterised in that the door lock further comprises a turnable lever member (7), which is turnably connected to the body part (4B), the turnable lever member (7) comprising a detent surface (8) and a connection surface (9), the arm part (5B) comprising a counter connection surface (10), and the door lock comprising a counter detent surface (11) in connection with the body part,
which turnable lever member (7) is arranged to pull the auxiliary bolt (5) inside the door lock (1) when the latch bolt (4) is moved inside the door lock, the detent surface (8) being against the counter detent surface (11) and the connection surface (9) being against the counter connection surface (10) when moving the auxiliary bolt (5) inside the door lock,
and when the door lock (1) is not against a door frame, the oblique part (4A) mostly outside the door lock, the latch bolt (4) is arranged to remain its position regardless of a position of the auxiliary bolt (5) by a retainer surface (17) of the turnable lever member and a counter retainer surface (18) of the door lock,
which retainer surface (17) is arranged to be against the counter retainer surface (18) in said position of the oblique part (4A) mostly outside the door lock when the door lock is not against the door frame.

2. A door lock according to claim 1, characterised in that lock body (2) has a front plate (3) with a hole (25) for the latch bolt (4), the latch bolt and the auxiliary bolt being spring loaded outside the lock body (2).

3. A door lock according to claim 2, characterised in that the counter connection surface (10) is towards the front plate (3).

4. A door lock according to claim 3, characterised in that the counter detent surface (11) is a part of the body part (4B).

5. A door lock according to claim 3, characterised in that the counter detent surface (11) is a part of one part of the force transmission means (14).

6. A door lock according to any of claim 3-5, characterised in that the turnable lever member (7) comprises a projection (17A) which provides the retainer surface 17, and the lock body comprises a recess (18A) for the projection, which recess provides the counter retainer surface (18), and which projection is arranged to be in the recess when the door lock is not against a door frame, the latch part mostly outside the door lock, the projection against the recess preventing the latch bolt to move to the dead locked position.

7. A door lock according to any of claims 3-6, characterised in that the arm part (5B) comprises a pin (19), and the counter connection surface (10) is a part of a pin (19).

8. A door lock according to any of claims 1-7, characterised in that the door lock comprises a module structure (20) inside the lock body, the module structure comprising the latch bolt (4), the auxiliary bolt (5) and the turnable lever member (7).

9. A door lock according to claim 8, characterised in that the module (20) comprises the counter retainer surface (18).

10. A door lock according to any of claims 1-9, characterised in that it lock body comprises a lock cylinder torsion element (16) and/or a follower (13) of an operation axis (21), and force transmission means (14) to move the latch bolt (4) inside the lock body, the force transmission means (14) being in connection with latch bolt (4) and also with the lock cylinder torsion element (16) and/or the follower (13) of the operation axis.

11. A door lock according to claim 10, characterised in that the transmission means (14) comprises a plate part (14A) being turnably connected to the module structure.
